(19) United States
(12) Patent Application Publication
(10) Pub. No.: US 2022/0049649 A1
(43) Pub. Date: Feb. 17, 2022

(54) System and Methods for Recycling Hydrocarbon Waste Gas That is Generated During Cleaning of a Hydrocarbon Storage Tank

(71) Applicant: Path Environmental Technology, LLC, Houston, TX (US)

(72) Inventors: Kelan Samuel McElduff, Fair Haven, NJ (US); Adam Mark McGuire, The Woodlands, TX (US)

(21) Appl. No.: 17/404,726

(22) Filed: Aug. 17, 2021

Related U.S. Application Data
(60) Provisional application No. 63/066,745, filed on Aug. 17, 2020.

(51) Int. Cl. F02C 3/22

(52) U.S. Cl. CPC F02C 3/22; F05D 2220/75; F05D 2220/76

(57) ABSTRACT

A hydrocarbon waste-gas recycling method having the steps of: transporting a hydrocarbon waste-gas composition, which is generated during a hydrocarbon storage-tank cleaning process, from a storage tank that is being cleaned to a fuel-gas blend controller; blending the hydrocarbon waste-gas composition with a second hydrocarbon gas-phase composition to thereby create a third gas-phase composition; and using the third gas-phase composition to fuel a combustion engine.

### CROSS-REFERENCE TO RELATED APPLICATIONS

This patent application claims priority to U.S. provisional patent application 63/066,745 filed on Aug. 17, 2020. The subject matter of U.S. provisional patent application 63/066,745 is incorporated by reference into this patent application.

### BACKGROUND OF THE INVENTION

Systems and processes for cleaning the insides of crude-oil storage tanks are known.

Performing these known crude-oil storage-tank cleaning processes has the unwanted consequence of creating hydrocarbon-waste gases that are commonly referred to as hazardous-waste gases. To dispose of hazardous-waste gases (that are being created during a crude-oil storage-tank cleaning process), they are commonly removed from inside of the storage tank using an exit pipeline that transports the hazardous-waste gases directly to a thermal-oxidizer combustion unit for incineration. After incinerating the hazardous-waste gases and thereby creating after-incineration reaction products, the after-incineration reaction products are then vented into the atmosphere.

As a non-limiting example of a known crude-oil storage-tank cleaning process, FIG. 1 is a schematic representation that shows a known cleaning-system configuration for cleaning a crude-oil storage tank. In FIG. 1, the double line that exits the crude-oil storage tank represents an exit pipeline that transports hazardous-waste gases directly to a thermal-oxidizer combustion unit for incineration. The after-incineration reaction products are then vented from the thermal oxidizer to the atmosphere as shown in FIG. 1.

A need remains for a crude-oil storage-tank cleaning system and process that is more environmentally friendly, reduces the use of conventional hydrocarbon fuel sources, and reduces carbon emissions.

### BRIEF SUMMARY OF THE INVENTION

A hydrocarbon waste-gas recycling method having the steps of: transporting a hydrocarbon waste-gas composition, which is generated during a hydrocarbon storage-tank cleaning process, from a storage tank that is being cleaned to a fuel-gas blend controller; blending the hydrocarbon waste-gas composition with a second hydrocarbon gas-phase composition to thereby create a third gas-phase composition; and using the third gas-phase composition to fuel a combustion engine.

A hydrocarbon waste-gas recycling system having: a hydrocarbon storage tank; a pipeline configured to transport a hydrocarbon waste-gas composition, which is generated during a hydrocarbon storage-tank cleaning process, from the storage tank to a fuel-gas blend controller; the fuel-gas blend controller configured to combine the hydrocarbon waste-gas composition with a second gas-phase composition to thereby create a third gas-phase composition; the fuel-gas blend controller further configured to emit controlled amounts of the third gas-phase composition; and a combustion engine configured to receive and use the third gas-phase composition as a fuel source.

A hydrocarbon waste-gas recycling system having: a crude-oil storage tank; a pipeline configured to transport a hydrocarbon waste-gas composition, which is generated during a hydrocarbon storage-tank cleaning process, from the storage tank to a fuel-gas blend controller; the fuel-gas blend controller configured to combine the hydrocarbon waste-gas composition with propane gas to thereby create a third gas-phase composition; the fuel-gas blend controller further configured to emit controlled amounts of the third gas-phase composition; a combustion engine configured to receive and use the third gas-phase composition as a fuel source; the combustion engine configured to power an electric generator; an electric motor configured to receive electricity from the electric generator; and the electric motor is in an apparatus selected from the group consisting of an air compressor, a hydraulic pump, a pneumatic pump, a centrifuge, a shaker, and a heat exchanger.

### BRIEF DESCRIPTION OF THE SEVERAL VIEWS OF THE DRAWINGS

FIG. 1 is a schematic that shows a prior-art system for cleaning a crude-oil storage tank.

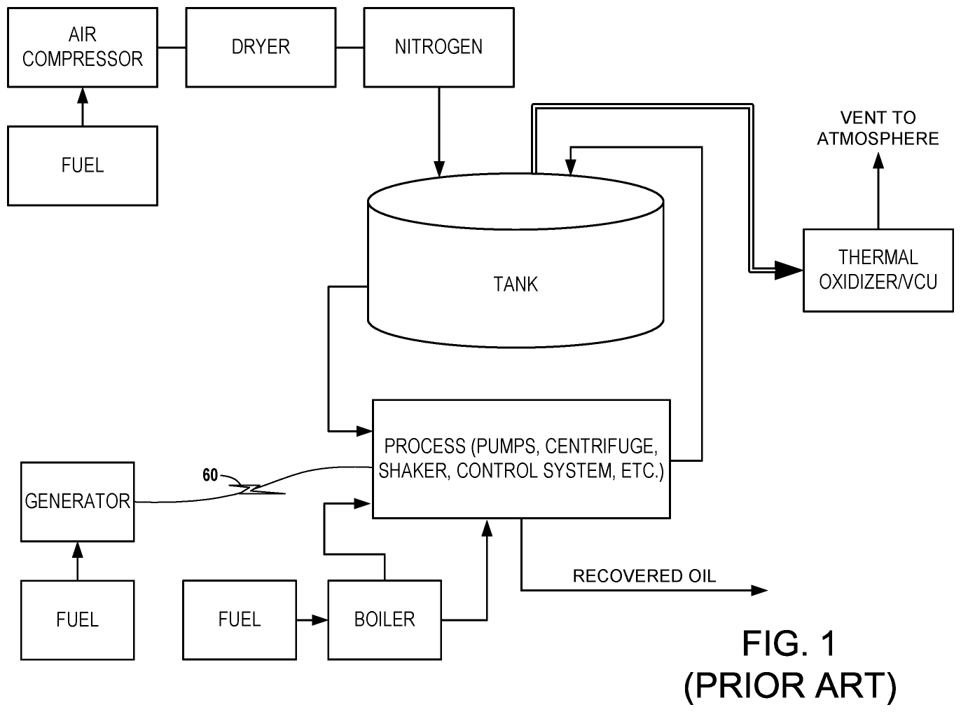

FIG. 2 is a schematic showing an embodiment of the invention.

FIG. 3 is a schematic showing an embodiment of the invention.

### DETAILED DESCRIPTION OF THE INVENTION

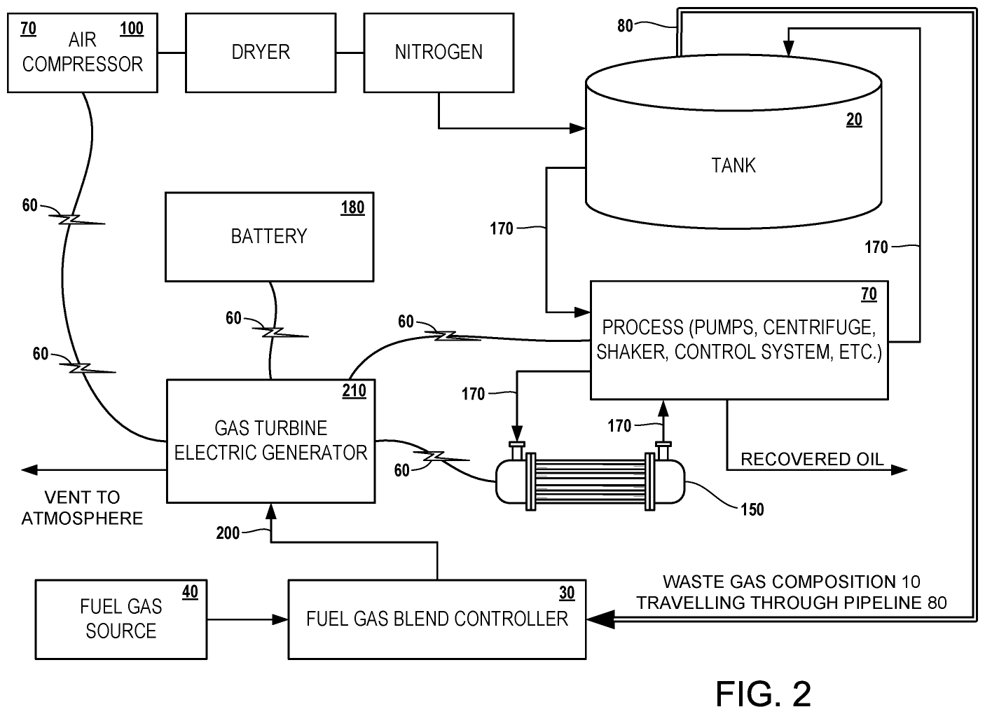

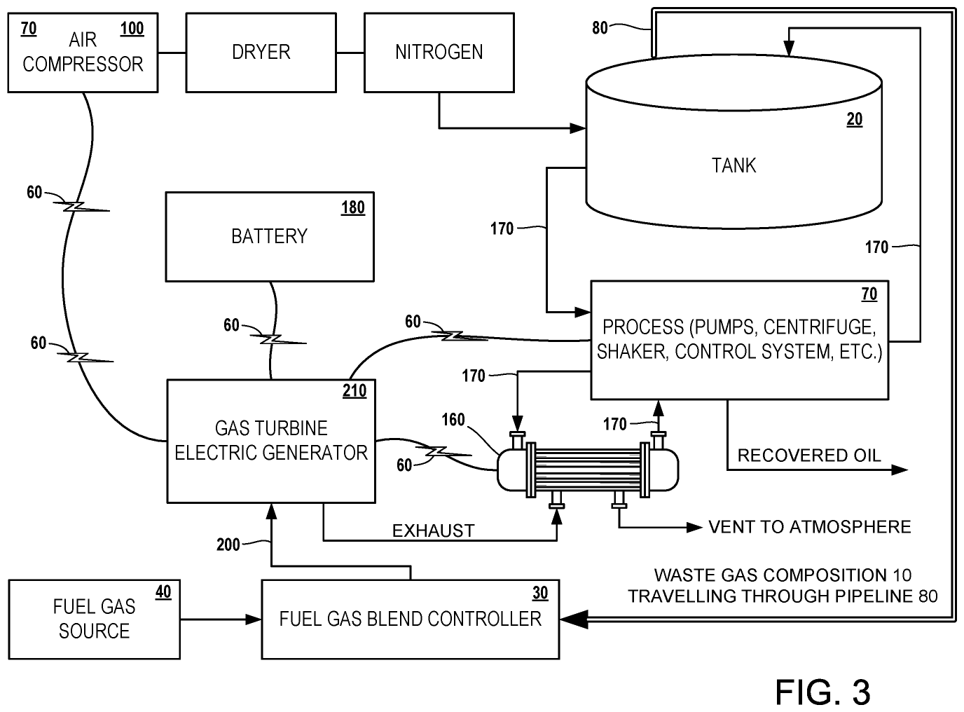

Embodiments are directed to recycling unwanted hazardous waste gases that are produced during the performance of processes directed to cleaning the inside of crude-oil storage tanks or other types of hydrocarbon storage tanks. Recycling of these unwanted hazardous waste gases is achieved by using the unwanted hazardous waste gases as a combustible fuel source for combustion engines. Recycling embodiments are described with reference to the schematic representations shown in FIGS. 2 and 3.

FIGS. 2 and 3 show systems for cleaning crude-oil storage tank 20. Crude oil and crude-oil derivatives containing varying percentages of water and sediment 170 are shown circulating in and out of crude-oil storage tank 20 as they would during a standard cleaning process. Pipeline 80 has a sealed connection to crude-oil storage tank 20 and transports waste gas composition 10 from crude-oil storage tank 20 directly to fuel-gas blend controller 30.

Fuel-gas blend controller 30 is configured to both receive waste gas composition 10 from pipeline 80 and blend waste gas composition 10 with fuel gas source or second gas-phase composition 40 to thereby generate third gas-phase composition 200 (that is a blend of waste gas composition 10 and fuel gas source or second gas-phase composition 40). In embodiments, fuel gas source or second gas-phase composition 40 is propane gas. In other embodiments, fuel gas source or second gas-phase composition 40 is any known combustible gas-phase composition used as a combustion-engine fuel source. By blending waste gas composition 10 with second gas-phase composition 40 such as propane, the resultant third gas-phase composition 200 can be used as a gas-phase fuel source to power a combustion engine such as that used in gas turbine electric generator 210. By introducing a blended ratio of waste gas composition 10 and as a combustible fuel source into a combustion engine, waste gas composition 10 is recycled as a fuel source (versus being otherwise incinerated and serving no useful purpose).

In embodiments, fuel-gas blend controller 30 blends waste gas composition 10 with fuel gas source or second gas-phase composition 40 respectively at the following volume-based ratios: 100/0; 95/5; 90/10; 85/15; 80/20; 75/25; 70/30; 65/35; 60/40; 55/45; 50/50; 45/55; 40/60; 35/65; 30/70; 25/75; 20/80; 15/85; 10/90; or 5/95. In embodiments, the resultant blended third gas-phase composition 200 results from blending waste gas composition 10 with fuel gas source or second gas-phase composition 40 at a volume-based ratio that will result in the third gas-phase composition 200 being useful as a combustible fuel source to power a combustion engine such as that used in gas turbine electric generator 210. Persons of ordinary skill in the art will be able to determine useful volume-based recycling blend ratios without having to exercise undue experimentation.

Fuel-gas blend controller 30 can be any commercially known fuel-gas blend controller that is configured to: i) receive and blend controlled ratios of at least two different gas-phase compositions into one blended resultant gas-phase composition, and ii) emit controlled and measured amounts of the one blended resultant gas-phase composition. Fuel-gas blend controller 30 is configured to emit the one blended resultant gas-phase composition in amounts and rates to be determined by persons of ordinary skill in the art without having to exercise undue experimentation.

As shown in FIGS. 2 and 3, fuel-gas blend controller 30 emits the one blended resultant gas-phase composition, i.e., third gas-phase composition 200, to gas turbine electric generator 210 that generates electricity 60. In embodiments, a pipeline is used to transport the one blended resultant gas-phase composition, i.e., third gas-phase composition 200, from fuel-gas blend controller 30 to gas turbine electric generator 210.

Gas turbine electric generator 210 can be any known apparatus configured to generate electricity by using a combustion engine; gas-driven electric generators are well known and commercially available.

As shown in FIGS. 2 and 3, embodiments allow for any form of electrical current 60 generated by gas turbine electric generator 210 to be used to power at least one electric motor within a variety of electrically powered components 70. A non-limiting example of electrically powered components 70 includes: air compressor 100, hydraulic pump 110, pneumatic pump 120, centrifuge 130, shaker 140, and heat recovery unit 160. In an embodiment, any form of electrical current 60 is stored in battery 180.

In an embodiment, as shown in FIG. 3, exhaust from gas turbine electric generator 210 is transported to turbine heat recovery unit (HRU)/heat exchanger 160; heat is recovered from the exhaust and used to heat crude oil and crude-oil derivatives containing varying percentages of water and sediment 170 circulated during a cleaning process. Turbine HRU/heat exchanger 160 then emits and vents exhaust to the atmosphere.

Although the above embodiments have been explained with specific reference to crude-oil storage tanks, crude oil, and crude-oil derivatives containing varying percentages of water and sediment crude oil; all of the above system and method embodiments can be practiced with storage tanks for other types of hydrocarbon compositions and their derivatives. As a non-limiting example, the inventive embodiments can be used to recycle hydrocarbon-composition gas-phase waste products in many, if not all, storage tanks generally used in oil-refining or hydrocarbon-composition storing technologies.

Persons of ordinary skill in the art will appreciate that embodiments can be understood beyond the specific teachings provided above.

What is claimed is:

1. A hydrocarbon waste-gas recycling method comprising the steps:
transporting a hydrocarbon waste-gas composition, which is generated during a hydrocarbon storage-tank cleaning process, from a storage tank that is being cleaned to a fuel-gas blend controller;
blending the hydrocarbon waste-gas composition with a second hydrocarbon gas-phase composition to thereby create a third gas-phase composition; and
using the third gas-phase composition to fuel a combustion engine.

2. The hydrocarbon waste-gas recycling method of claim 1, wherein the hydrocarbon storage-tank cleaning process is a crude-oil storage-tank cleaning process.

3. The hydrocarbon waste-gas recycling method of claim 1, wherein the combustion engine powers an electric generator.

4. The hydrocarbon waste-gas recycling method of claim 1, wherein the second hydrocarbon gas-phase composition is propane gas.

5. The hydrocarbon waste-gas recycling method of claim 3, further comprising the step of using electricity generated by the electric generator to power at least one electric motor.

6. The hydrocarbon waste-gas recycling method of claim 1, further comprising the step of using a heat recovery unit to recover heat from exhaust emitted by the combustion engine.

7. The hydrocarbon waste-gas recycling method of claim 1, wherein a pipeline is used to transport the hydrocarbon waste-gas composition from the storage tank that is being cleaned to the fuel-gas blend controller.

8. The hydrocarbon waste-gas recycling method of claim 1, wherein a pipeline is used to transport the hydrocarbon waste-gas composition from the storage tank that is being cleaned to the fuel-gas blend controller.

9. The hydrocarbon waste-gas recycling method of claim 5, wherein the at least one electric motor is in an apparatus selected from the group consisting of an air compressor, a hydraulic pump, a pneumatic pump, a centrifuge, a shaker, and a heat exchanger.

10. The hydrocarbon waste-gas recycling method of claim 3, further comprising the step of using electricity generated by the electric generator to charge a battery.

11. A hydrocarbon waste-gas recycling system comprising:
a hydrocarbon storage tank;
a pipeline configured to transport a hydrocarbon waste-gas composition, which is generated during a hydrocarbon storage-tank cleaning process, from the storage tank to a fuel-gas blend controller;
the fuel-gas blend controller configured to combine the hydrocarbon waste-gas composition with a second gas-phase composition to thereby create a third gas-phase composition;
the fuel-gas blend controller further configured to emit controlled amounts of the third gas-phase composition; and
a combustion engine configured to receive and use the third gas-phase composition as a fuel source.

12. The hydrocarbon waste-gas recycling system of claim 11, wherein the hydrocarbon storage tank is a crude-oil storage tank.

13. The hydrocarbon waste-gas recycling system of claim 11, wherein the combustion engine is configured to power an electric generator.

14. The hydrocarbon waste-gas recycling system of claim 11, wherein the second hydrocarbon gas-phase composition is propane gas.

15. The hydrocarbon waste-gas recycling system of claim 13, further comprising an electric motor configured to receive electricity from the electric generator.

16. The hydrocarbon waste-gas recycling system of claim 13, further comprising a battery configured to receive and store electricity from the electric generator.

17. The hydrocarbon waste-gas recycling system of claim 11, further comprising a heat recovery unit configured to recover heat from exhaust emitted by the combustion engine.

18. The hydrocarbon waste-gas recycling system of claim 15, wherein the electric motor is in an apparatus selected from the group consisting of an air compressor, a hydraulic pump, a pneumatic pump, a centrifuge, a shaker, and a heat exchanger.

19. A hydrocarbon waste-gas recycling system comprising:
a crude-oil storage tank;
a pipeline configured to transport a hydrocarbon waste-gas composition, which is generated during a hydrocarbon storage-tank cleaning process, from the storage tank to a fuel-gas blend controller;
the fuel-gas blend controller configured to combine the hydrocarbon waste-gas composition with propane gas to thereby create a third gas-phase composition;
the fuel-gas blend controller further configured to emit controlled amounts of the third gas-phase composition;
a combustion engine configured to receive and use the third gas-phase composition as a fuel source;
the combustion engine configured to power an electric generator;
an electric motor configured to receive electricity from the electric generator; and
the electric motor is in an apparatus selected from the group consisting of an air compressor, a hydraulic pump, a pneumatic pump, a centrifuge, a shaker, and a heat exchanger.
